(19) United States
(12) Patent Application Publication
(10) Pub. No.: US 2016/0219459 A1
(43) Pub. Date: Jul. 28, 2016

(54) AGGREGATED WIRELINE BACKHAUL FOR WIRELESS MODEMS

(71) Applicant: Alcatel-Lucent USA Inc., Murray Hill, NJ (US)

(72) Inventors: Milind M. Buddhikot, Bridgewater, NJ (US); Lance Hartung, Madison, WI (US); Marcus K. Weldon, Summit, NJ (US)

(21) Appl. No.: 14/606,366

(22) Filed: Jan. 27, 2015

(51) Int. Cl. H04W 28/08; H04B 17/318

(52) U.S. Cl. CPC H04W 28/08; H04B 17/318

(57) ABSTRACT

A first wireless modem aggregates a wireline backhaul interface with a wireless interface to a second wireless modem in response to receiving signaling indicating availability of wireline backhaul capacity at the second wireless modem. A policy server transmits instructions to a first wireless modem to aggregate a wireline backhaul interface with a wireless interface to a second wireless modem based on availability of wireline backhaul capacity at the second wireless modem.

### CROSS REFERENCE TO RELATED APPLICATIONS

This application is related to U.S. patent application Ser. No. ______ (Attorney Docket No. 4100-817372-US), entitled “Interface Aggregation for Heterogeneous Wireless Communication Systems” and filed on even date herewith, the entirety of which is incorporated by reference herein.

### GOVERNMENT LICENSE RIGHTS

This invention was made with Government support under Contract Number NSF-CNS-1117597 awarded by the U.S. National Science Foundation. The Government has certain rights in this invention.

### BACKGROUND

1. Field of the Disclosure

The present disclosure relates generally to wireless communication systems and, more particularly, to wireless modems in wireless communication systems.

2. Description of the Related Art

Traditionally, users accessed the Internet via a wireline connection to a modem that was connected to the network by a direct subscriber line (DSL), a cable connection, a fiberoptic connection, or other wired interface. Examples of wireline access networks include a DSL network, a cable network, a fiber-in-the-home (FTTH) network, or a fiber-to-the-neighborhood (FTTN) network. User equipment such as desktop computers or laptop computers can be connected to the modem by a wired Ethernet connection. Modems may also be enhanced to provide wireless connectivity by including an integrated wireless access point. Alternatively, the modem may be connected to a wireless access point that is co-located with the modem to provide wireless connectivity. The combination of the modem and the (integrated or co-located) wireless access point may be referred to as a wireless modem. Wireless modems can be used to provide wireless connectivity within a corresponding geographic area. The internet access speed supported by a wireless modem is limited by the capacity of the wireline backhaul connection from the network to the wireless modem.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided for aggregating wireline backhaul for wireless modems. The method includes aggregating, at a first wireless modem, a wireline backhaul interface with a wireless interface to a second wireless modem in response to receiving signaling indicating availability of wireline backhaul capacity at the second wireless modem.

In some embodiments, a method is provided for instructing wireless modems to form an aggregated wireline backhaul. The method includes transmitting, from a policy server, instructions to a first wireless modem to aggregate a wireline backhaul interface with a wireless interface to a second wireless modem based on availability of wireline backhaul capacity at the second wireless modem.

In some embodiments, a wireless modem is provided to form an aggregated wireline backhaul. The wireless modem includes a wireline backhaul interface, a wireless interface, and a processor to aggregate the wireline backhaul interface the wireless interface in response to receiving signaling indicating availability of wireline backhaul capacity at another wireless modem.

In some embodiments, an apparatus is provided to instruct wireless modems to form an aggregated wireline backhaul. The apparatus includes a transceiver to transmit instructions to aggregate a wireline backhaul interface in a first wireless modem with a wireless interface to a second wireless modem based on availability of wireline backhaul capacity at the second wireless modem.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a wireless communication system according to some embodiments.

FIG. 2 is a block diagram of a wireless communication system according to some embodiments.

FIG. 3 is a block diagram of an aggregation proxy according to some embodiments.

FIG. 4 is a diagram of a method of configuring an aggregation proxy that supports a client-side socket (CSS) and a server-side socket (SSS) according to some embodiments.

FIG. 5 is a diagram of a method for aggregating wireline and wireless interfaces at a client according to some embodiments.

FIG. 6 is a block diagram of a wireless communication system according to some embodiments.

### DETAILED DESCRIPTION

The backhaul bandwidth of a wireless modem may be increased by aggregating the wireless modem's wireline backhaul link with one or more wireless communication links to one or more neighboring wireless modems. As used herein, the term “aggregate” is understood to refer to the concurrent use of multiple interfaces to support sub-flows of a flow associated with the aggregated interfaces. The bandwidth available to the flow may be substantially equal to the sum of the bandwidths of the sub-flows supported by the aggregated interfaces. Service providers or applications may therefore provide flows using the increased bandwidth provided by the sub-flows of the aggregated interfaces. By aggregating the wireline backhaul link with one or more wireless communication links, the total backhaul bandwidth available to the wireless modem may be increased to as high as a sum of the backhaul bandwidths of the wireline backhaul link to the wireless modem and the wireline backhaul links to the one or more neighboring wireless modems. In some embodiments, the wireless modem may aggregate its wireline backhaul link and the wireless communication links in response to a load on the wireless modem exceeding a first threshold, a load on a neighboring wireless modem falling below a second threshold that indicates under-utilization of a wireline connection from the neighboring wireless modem to the network, or a combination thereof.

Each wireless modem implements interfaces for the wireline and wireless connections. A network-resident policy server implemented at the network layer (Layer 3) or transport layer (Layer 4) may select a subset of the interfaces for aggregation using registration information provided by the wireless modem. Some embodiments of the policy server select interfaces that have relative delays or latencies that are less than a threshold value. User input may be used to negotiate or confirm aggregation of the subset, e.g., in the event that one or more of the plurality of interfaces requires additional payment. A dedicated bidirectional signaling channel may be established between the policy server and a policy agent in the wireless modem. The dedicated bidirectional signaling channel may be used to indicate the wireless interfaces available for aggregation with the wireline backhaul link, applications that are allowed to use the aggregated wireline and wireless interfaces, or prices or costs associated with the aggregated interfaces. The dedicated bidirectional signaling channel may also be used to convey a request message including descriptions of capabilities of the interfaces.

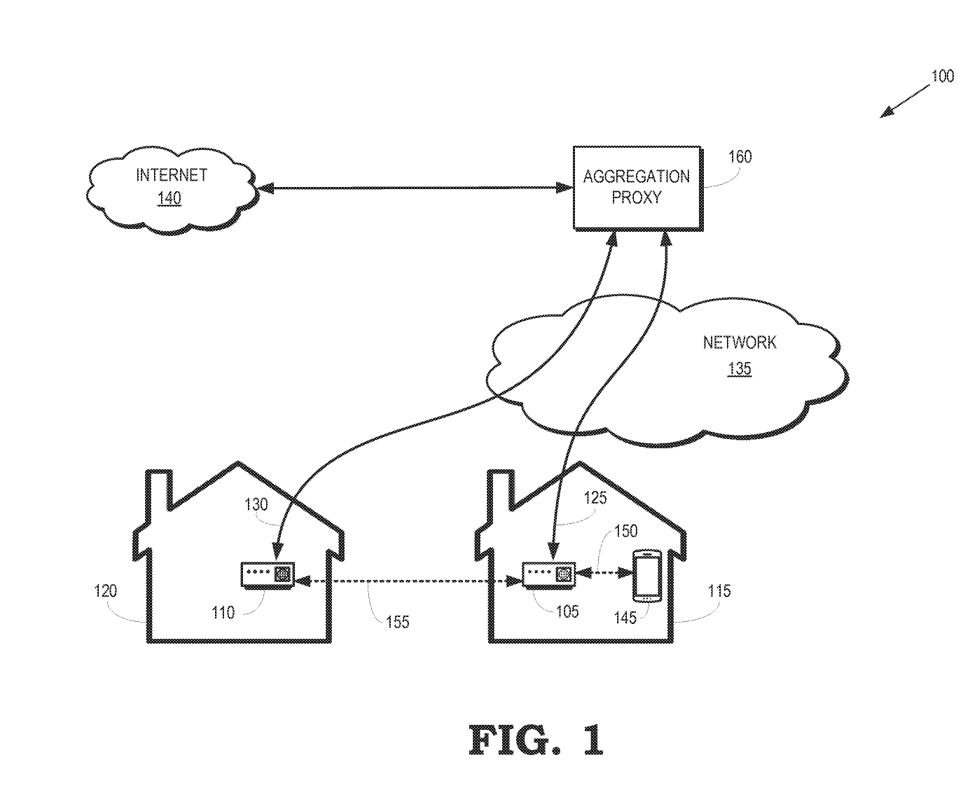

FIG. 1 is a block diagram of a wireless communication system 100 according to some embodiments. The wireless communication system 100 includes wireless modems 105, 110 that may be used to provide wireless connectivity in geographic areas associated with buildings 115, 120. However, some embodiments of the wireless modem 110 may not be implemented in a building 120 and may instead be deployed in another location such as a pole top location. Moreover, the wireless modem 110 may be implemented indoors or outdoors. The wireless modems 105, 110 may be implemented using integrated wireless access points or co-located access points. Wireline backhaul links 125, 130 are used to provide backhaul connections between the wireless modems 105, 110 and a network 135 or the Internet 140. User equipment 145 may therefore access the network 135 or the Internet 140 by establishing a wireless communication link 150 with the wireless modem 105. The wireless communication link 150 may be established according to any radio access technology, including radio access technologies implemented according to the Long Term Evolution (LTE) standards established by the Third Generation Partnership Project (3GPP) or Wi-Fi standards established by the Institute of Electrical and Electronics Engineers (IEEE). The wireless communication link 150 may also be established in licensed or unlicensed frequency bands.

The wireless modems 105, 110 implement wireline interfaces and wireless interfaces. For example, the wireless modem 105 implements one or more wireline backhaul interfaces to connect the wireless modem 105 to the wireline backhaul link 125 and support communication over the wireline backhaul link 125. The wireless modem 105 also implements one or more wireless interfaces to support wireless connectivity e.g., for communication with the user equipment 145 over the wireless communication link 150. The wireless modem 110 also implements one or more wireline backhaul interfaces to support communication over the wireline backhaul link 130 and one or more wireless interfaces to support wireless connectivity. The wireless interfaces in the wireless modems 105, 110 may also be used to establish a wireless communication link 155 between the wireless modems 105, 110. The wireless modem 105 may use the wireless communication link 155 to increase the backhaul bandwidth available to the wireless modem 105. For example, the wireless modem 105 may aggregate its wireline backhaul interface with the wireless interface to the wireless communication link 155 so that backhaul communications can be exchanged over both of the wireline backhaul links 125, 130. The total available bandwidth for the backhaul communications may therefore be increased to as much as the sum of the bandwidths of the wireline backhaul links 125, 130.

An aggregation proxy server 160 terminates the aggregated wireline backhaul links 125, 130. The aggregation proxy server 160 is a transparent, network-resident proxy server that partitions a connection (e.g., to the Internet 140 or one or more applications connected to the Internet 140) to support aggregation of the wireline backhaul interfaces in the wireless modems 105, 110. Some embodiments of the aggregation proxy server 160 provide a single connection for each flow from the Internet 140 to the aggregation proxy server 160. For example, the single connection may be a legacy transmission control protocol (TCP) or multipath TCP (MPTCP) connection. The aggregation proxy server 160 also provides a multipath connection from the aggregation proxy server 160 to the wireless modems 105, 110. For example, the aggregation proxy server 160 may support a set of multipath connections that include a plurality of MPTCP sub-flows and each MPTCP sub-flow may be used to convey information over one of the wireline backhaul links 125, 130. One of the set of multipath connections may be established between the aggregation proxy 160 and a wireline backhaul interface that connects the wireless modem 105 to the wireline backhaul link 125. A second one of the set may be established between the aggregation proxy 160 and a wireless interface that connects the wireless modem 105 to the wireless modem 110. The second multipath connection may therefore be established over the wireline backhaul link 130, a wireline backhaul interface in the wireless modem 110, a wireless interface in the wireless modem 110, and the wireless communication link 155.

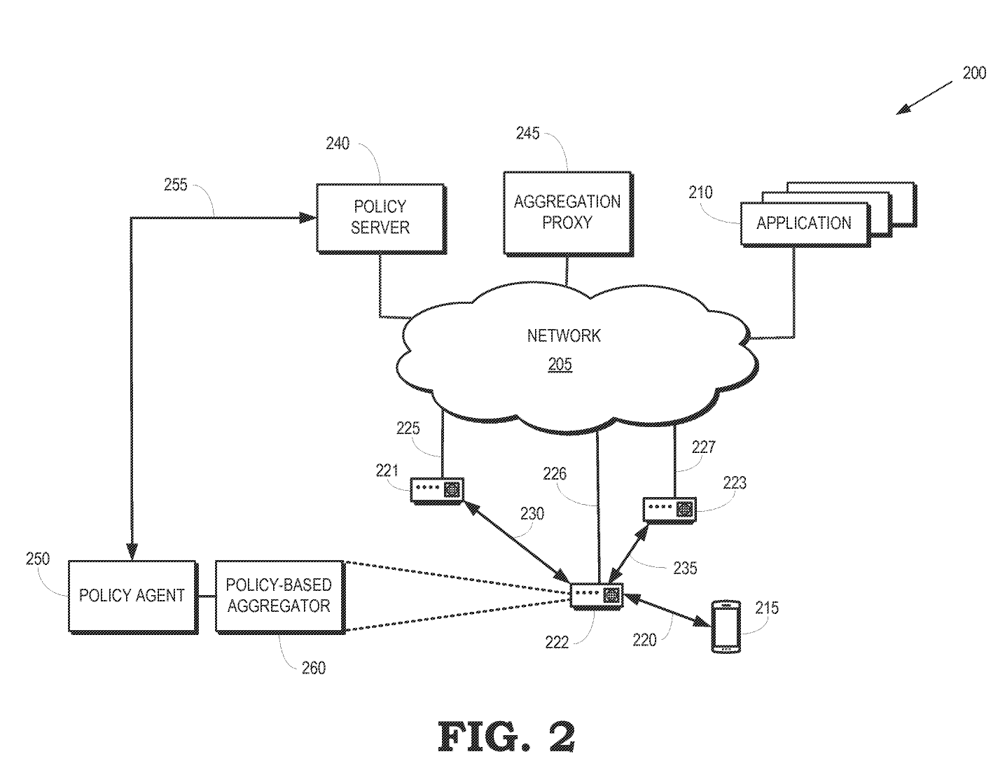

FIG. 2 is a block diagram of a wireless communication system 200 according to some embodiments. The wireless communication system 200 includes a network 205 that is used to convey signals associated with one or more applications 210. Examples of applications 210 that may use the network 205 to transmit or receive signals include Netflix, Hulu, Vudu, YouTube, and other multimedia streaming applications. The wireless communication system 200 also includes wireless modems 221, 222, 223, which are collectively referred to herein as “the wireless modems 221-223.” The wireless modems 221-223 may be implemented in a home, in an office building, on a pole external to a building, or in other locations. The wireless modems 221-223 are connected to the network 205 by corresponding wireline backhaul links 225, 226, 227, which are collectively referred to herein as “the wireline backhaul links 225-227.” Each of the wireless modems 221-223 therefore supports one or more wireline interfaces (not shown in FIG. 2) to connect the wireless modems 221-223 to the corresponding wireline backhaul links 225-227.

Each of the wireless modems 221-223 also supports one or more wireless interfaces (not shown in FIG. 2) that operate according to different radio access technologies or in different frequency bands. For example, the wireless modems 221-223 may implement one or more cellular interfaces capable of operation in 3G bands according to code division multiple access (CDMA, W-CDMA) protocols or 4G bands according to FDD or TDD protocols defined by the LTE standards defined by 3GPP. The wireless modems 221-223 may also implement one or more Wi-Fi interfaces capable of operation in 2.4 gigahertz (GHz) unlicensed bands or 5 GHz unlicensed bands according to the 802.11 standards defined by the IEEE. Wireless users can access services provided by the applications 210 by establishing a wireless communication link with one or more of the wireless modems 221-223. For example, the user equipment 215 can establish a flow with one or more of the applications 210 over a wireless communication link 220 with the wireless modem 222.

The wireless modems 221-223 are also able to communicate with each other wirelessly. For example, the wireless modem 221 and the wireless modem 222 may establish a wireless communication link 230. The wireless modem 222 and the wireless modem 223 may also establish a wireless communication link 235 over the air interface. Thus, the wireless modem 222 may support concurrent communication over multiple wireline or wireless interfaces. Some embodiments of the wireless modems 221-223 establish wireless communication links (such as the wireless communication links 230, 235) in response to detecting the presence of other wireless modems 221-223. For example, the wireless modem 221 can measure a strength of a signal (such as a pilot signal) transmitted by the wireless modem 222 and establish the wireless communication link 230 in response to the measured strength exceeding a predetermined threshold.

The wireless modems 221-223 can aggregate one or more wireline interfaces with one or more wireless interfaces to make use of available backhaul link capacity in neighboring wireless modems 221-223. Aggregating the wireline and wireless interfaces may therefore increase the bandwidth available to one or more flows associated with the applications 210. For example, the wireless modems 221-223 can aggregate the interfaces associated with the links 226, 230, 235 to support sub-flows of a single flow from the applications 210 to the user equipment 215.

The wireless communication system 200 includes a policy server 240 that is used to select the wireless interfaces that may be aggregated with the interfaces of the wireline backhaul links 225-227 of the wireless modems 221-223. The policy server 240 may be implemented as a network-resident server (e.g., the policy server 240 is resident in the wireless communication system 200) that manages the wireless modems 221-223, as well as the user equipment 215 and any other user equipment in the wireless communication system 200. The policy server 240 manages these entities based upon policies associated with the applications 210 or the user equipment 215, e.g., to achieve target objectives such as maximum user throughputs, best user experience for predetermined user classes or application classes, monetization of the provision of increased capacity of the wireless modems 221-223, and the like. The set of wireless modems 221-223 and user equipment 215 that are managed by the policy server 240 may be referred to as the “aggregation scope” of the policy server 240.

The policy server 240 selects the wireless interfaces for aggregation based on availability of wireline backhaul capacity at the wireless modems 221-223. For example, the policy server 240 selects the wireless interface associated with the wireless communication link 230 for aggregation with the wireline backhaul link 226 if the wireless modem 221 has excess capacity on the wireline backhaul link 225. If the wireless modem 221 does not have sufficient access capacity, the policy server 240 does not select the corresponding wireless interface for aggregation. The excess capacity may be present because a load on the wireless modem 221 is below a load threshold or because the owner of the wireless modem 221 has paid for a smaller amount of capacity than can be supported by the wireless modem 221. The policy server 240 may request information indicating the capacities of the wireless modems 221-223, which may then provide this information. The policy server 240 may also access the capacity information from a database.

Each interface supported by the wireless modems 221-223 corresponds to a different path through the wireless communication system 200. For example, there are three paths between the wireless modem 222 and the network 205: (1) the wireline backhaul link 226 provides a first path from the wireless modem 222 to the network 225, (2) the wireless communication link 230, the wireless modem 221, and the wireline backhaul link 225 provide a second path from the wireless modem 222 to the network 225, and (3) the wireless communication link 235, the wireless modem 223, and the wireline backhaul link 227 provide a third path from the wireless modem 222 to the network 225. The policy server 240 may select a subset of the interfaces corresponding to paths with similar characteristics to achieve high aggregation efficiency. Multipath aggregation performs particularly well when the component paths have similar delay characteristics and may not perform as well if the relative delays between signals transmitted on the different component paths exceeds a threshold. Some embodiments of the policy server 240 may therefore implement policies that eliminate or reduce aggregation of interfaces associated with paths having different delay characteristics.

Some embodiments of the policy server 240 may also use other information such as network conditions, a user profile, a payment confirmation, and the like to select the wireless interfaces that may be aggregated with the wireline backhaul links 225-227 of the wireless modems 221-223. Some embodiments of the policy server 240 may support differential service (e.g., providing different quality of service to different users) by adjusting multipath usage in a way that is sensitive to users' service classes or priorities. Some embodiments of the policy server 240 may also be integrated with a network billing system (not shown in FIG. 2) to tie insertion of policies allowing greater per-user/app capacity with payment to monetize higher grade of service.

An aggregation proxy server 245 is connected to the policy server 240 via the network 205. As discussed herein, the aggregation proxy server 245 may be a transparent, network-resident proxy server that terminates the aggregated wireline backhaul links 225-227. The aggregation proxy server 245 can partition a connection between one or more of the applications 210 and the user equipment 215 to support aggregation of wireline and wireless interfaces at the wireless modems 221-223. Some embodiments of the aggregation proxy server 245 provide a single connection for each flow from the applications 210 to the aggregation proxy server 245 and a multipath connection from the aggregation proxy server 245 to the wireless modems 221-223 over the aggregated wireline and wireless interfaces.

The wireless modems 221-223 implement policy agents that communicate with the policy server 240. For example, the wireless modem 222 implements a policy agent 250 that communicates with the policy server 240 over a dedicated bidirectional signaling channel 255. The policy agent 250 may generate registration messages that include information identifying the capabilities of the wireless interfaces supported by the wireless modem 222, such as the channel capacities of the interfaces. The policy agent 250 may also generate information indicating values of performance measurements made by the wireless modem 222, such as instantaneous or time-averaged values of the measured signal strength, transmission rate, loss rate, and the like for signals transmitted over the wireless communication links 220, 230, 235. The information generated by the policy agent 250 may then be transmitted over one or more uplink channels of the dedicated bidirectional signaling channel 255. The policy agent 250 may also receive information over one channels of the dedicated bidirectional signaling channel 255. For example, the policy agent 250 may receive information indicating the wireless interfaces selected by the policy server 240 for aggregation, the applications 210 that are allowed to use the aggregated interfaces, a price or cost for using the aggregated interfaces, a request to perform one or more measurements, and the like.

The wireless modems 221-223 may also implement policy-based aggregators that are connected to a corresponding policy agent. For example, the wireless modem 222 implements a policy-based aggregator 260 that is connected to the policy agent 250. Some embodiments of the aggregator 260 translate the policies (e.g., the information identifying the wireless interfaces selected for aggregation) provided by the policy server 240 to control the traffic flows over the aggregated interfaces. For example, the aggregator 260 may implement an application programming interface (API), such as a Netlink socket API, which can be used by the policy agent 250 to signal to a modified MPTCP protocol stack in the wireless modem 222 to turn one or more sub-flows on for each active MPTCP connection corresponding to an application, the user, or the user equipment 215. The policy agent 250 may also use the API to turn off one or more sub-flows, e.g., in response to the policy server 240 removing one or more interfaces from the subset that is aggregated by the wireless modem 222.

Policy signaling between the policy server 240 and the policy agent 250 over the dedicated bidirectional signaling channel 255 may be performed according to different protocols. Some embodiments of the policy server 240 and the policy agent 250 may communicate using protocols that support a “chat” framework so that the policy server 240 and the policy agent 250 may interact with each other. For example, the chat framework may be used to negotiate payment of fees required for communication over one or more of the wireline or wireless interfaces prior to allowing information to be exchanged over the corresponding interface. The negotiation may include the policy server 240 transmitting a proposed fee for communication over one or more of the wireless interfaces and the policy agent 250 responding with a counter offer or confirmation that the user accepts the proposed fee. The negotiation may iterate until the policy server 240 and the policy agent 250 agree on the proposed fee or the policy agent 250 declines to accept the fee. Some embodiments of the policy server 240 or the policy agent 250 may transparently support UDP traffic flows as well IPSEC traffic using a tunneling framework such as vtund in Linux (which supports TCP tunneling) combined with packet filtering.

Components of the wireless communication system 200 may be partitioned into multiple layers that implement different functionality. The Open Systems Interconnection (OSI) model partitions functionality events these in the wireless communication system 100 into seven layers: a physical layer (Layer 1), a data link layer (Layer 2), a network layer (Layer 3), a transport layer (Layer 4), a session layer (Layer 5), a presentation layer (Layer 6), and an application layer (Layer 7). For example, the physical layer (PHY) defines the electrical and physical specifications of the data connection, the protocol to establish and terminate a connection between two nodes over a communication medium, modulation or conversion of digital data into analog signals for transmission over the communication medium, and other functionality related to the physical transmission of signals. The data link layer supports reliability by detecting and potentially correcting transmission errors that occur at the physical layer. The data link layer may be divided into a Media Access Control (MAC) layer and a Logical Link Control (LLC) layer. The network layer provides the functional and procedural means to transfer variable length data sequences between nodes in a network, e.g., by routing the messages through the network using addresses associated with the nodes. The network layer may also support fragmenting data sequences into fragments that can be delivered by different routes. The transport layer provides the functional and procedural means of transferring the variable length data sequences from a source to a destination host via one or more networks while maintaining the quality of service. For example, the transport layer may implement TCP or MPTCP. The transport layer may also support error control and packet retransmission.

Conventional mechanisms for providing higher bandwidth, such as carrier aggregation in LTE or increasing the channel width supported in a Wi-Fi network, are implemented in Layer 1 or Layer 2. Consequently, the conventional mechanisms are dependent on the specifications in standards produced by the 3GPP or the IEEE. In contrast, some embodiments of the policy server 240, the aggregation proxy server 245, the policy agent 250, or the policy-based aggregator 260 may be implemented at Layer 3 or Layer 4. Implementing aggregation of interfaces at Layer 3 or Layer 4 allows bandwidth to be flexibly or dynamically increased or decreased without requiring changes to the standards that govern implementation of baseband technologies at Layer 1 or Layer 2.

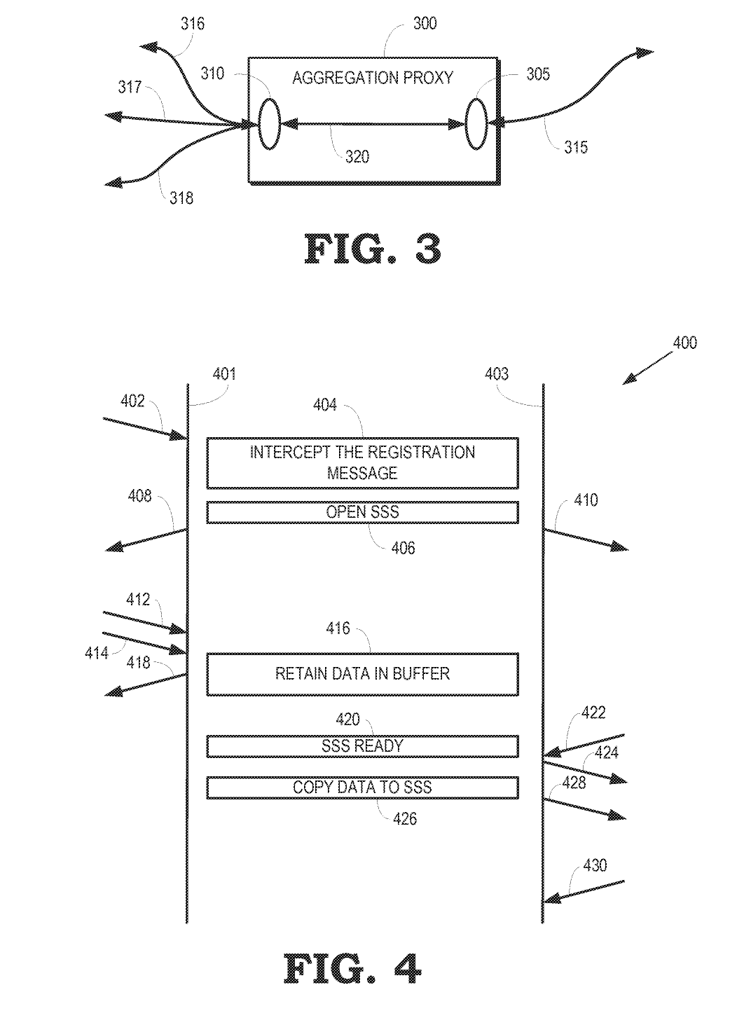

FIG. 3 is a block diagram of an aggregation proxy 300 according to some embodiments. The aggregation proxy 300 may be implemented in some embodiments of the aggregation proxy server 160 shown in FIG. 1 or the aggregation proxy server 245 shown FIG. 2. The aggregation proxy 300 includes a first socket 305, which may be referred to as a server-side socket, and a second socket 310, which may be referred to as a client-side socket. The first socket 305 may be used to establish a connection 315 with an application, such as one of the applications 210 shown in FIG. 2. The connection 315 may be used to support and terminate a flow between the application and the aggregation proxy 300. The second socket 310 may be used to support and terminate a plurality of connections 316, 317, 318 (referred to herein as “the connections 316-318”) to support sub-flows between the aggregation proxy 300 and aggregated wireline and wireless interfaces at a client such as the wireless modem 105 shown in FIG. 1 or the wireless modem 222 shown in FIG. 2. The aggregation proxy 300 may therefore copy (as indicated by arrow 320) and partition information received on a downlink portion of the connection 315 into multiple portions, which can then be distributed to the aggregated interfaces using the connections 316-318. The aggregation proxy 300 may also combine information received an uplink portions of the connections 316-318 and provide the combined information to the application using the connection 315.

Some embodiments of the aggregation proxy 300 may be implemented as a transparent split proxy using TCP or MPTCP to configure the socket 305 and the connection 315. The socket 310 or the connections 316-318 may be implemented using MPTCP. For example, routing may be configured so that the TCP connection setup procedure for a flow or sub-flow is performed by the aggregation proxy 300 in response to an MPTCP enabled client-side entity or server-side entity enabling a TCP sub-flow. The aggregation proxy 300 may detect the connection attempt using packet filtering mechanisms such as iptables defined in Linux. The aggregation proxy 300 may then configure the client side socket 310 to terminate one or more MPTCP connections (such as the connections 316-318) to interfaces aggregated by the client device and the server-side socket 305 to terminate an independent TCP connection (such as the connection 315) to an internet server/host for the application. Any further sub-flows between the client and the aggregation proxy 300 may be configured at the client-side socket 310 under the control of a policy server such as the policy server 240 shown in FIG. 2. Some embodiments of the aggregation proxy 300 can initiate multiple MPTCP sub-flows under the server-side socket 305 if the internet host supports MPTCP. The policy server may also control one or more sub-flows via the aggregation proxy 300.

FIG. 4 is a diagram of a method 400 of configuring an aggregation proxy that supports a client-side socket (CSS) and a server-side socket (SSS) according to some embodiments. The method 400 may be implemented in some embodiments of the aggregation proxy server 160 shown in FIG. 1, the aggregation proxy server 245 shown in FIG. 2, or the aggregation proxy 300 shown in FIG. 3. The line 401 indicates the client-side of the aggregation proxy and the line 403 indicates the server-side of the aggregation proxy. At 402, the aggregation proxy receives a registration message at a CSS from a client that includes a synchronization signal for synchronizing the client to an application. The registration message is intercepted (at 404) by the aggregation proxy, e.g., using packet filtering to detect the registration message. In response to intercepting the registration message, the aggregation proxy opens and initiates configuration of a sibling SSS socket at 406. At 408, the aggregation proxy responds to the client with an acknowledgment message indicating successful reception of the registration message. At 410, the aggregation proxy forwards the registration message with the synchronization signal to the server or host of the application indicated in the registration message. The server or host may then use the synchronization signal to synchronize the application and the client for subsequent communication.

At block 412, the aggregation proxy receives an acknowledgment message from the client at the CSS and, at block 414, the aggregation proxy begins receiving data from the client at the CSS. The data may be addressed to the server that supports the application but at this point configuration of the sibling SSS socket may not be complete. The aggregation proxy may therefore retain the data in a buffer at block 416. At 418, the aggregation proxy may transmit an acknowledgment message to the client indicating successful reception of the data. At block 420, the aggregation proxy determines that configuration of the sibling SSS socket is complete and the SSS socket is ready to transmit data associated with the flow between the client and the server that supports the application. At 422, the aggregation proxy receives an acknowledgment message indicating that the synchronization signal transmitted at 410 was successfully received by the server. At 424, the aggregation proxy transmits an acknowledgment message indicating successful reception of the technology message from the server. At this point, the CSS and SSS have been configured for the flow and the client is synchronized to the server. The aggregation proxy may therefore copy (at block 426) data retained in the buffer to the SSS socket and transmit the copy data to the server at 428. The aggregation proxy may receive an acknowledgment indicating successful reception of the data at 430.

The embodiment of the method 400 illustrated in FIG. 4 depicts configuration of the CSS and SSS sockets of the aggregation proxy in response to detecting a registration message transmitted by the client. The registration message is received at the CSS and triggers configuration of a sibling SSS socket. Other embodiments of the method 400 may be used to configure the CSS and SSS sockets of the aggregation proxy in response to detecting a registration message transmitted by the server that is hosting the application. For example, the aggregation proxy may receive a registration message at an SSS socket and the registration message may trigger configuration of a sibling CSS socket. The aggregation proxy may buffer data received from the client until the CSS socket has been configured and may subsequently copy the data to the CSS socket for transmission to the client over aggregated wireline and wireless interfaces, as discussed herein.

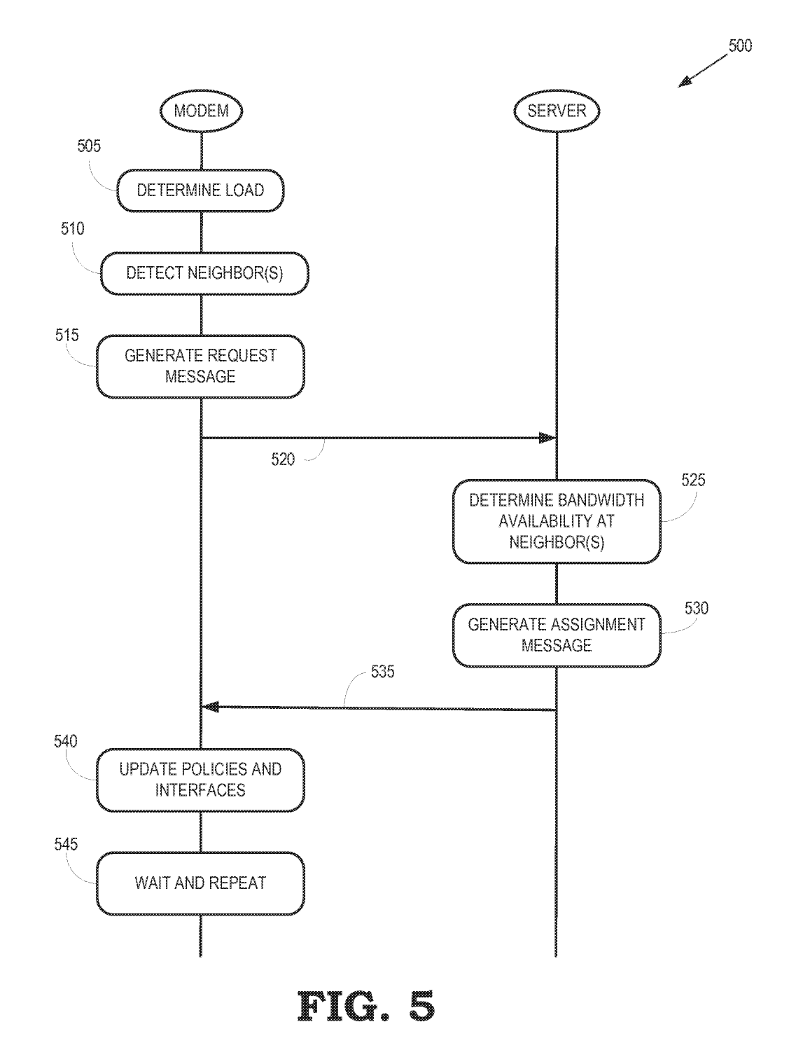

FIG. 5 is a diagram of a method 500 for aggregating wireline and wireless interfaces at a client according to some embodiments. The method 500 may be implemented in embodiments of the wireless communication system 100 shown in FIG. 1 or the wireless communication system 200 shown in FIG. 2. At block 505, a client (such as the wireless modem 105 shown in FIG. 1 or the wireless modem 222 shown in FIG. 2) determines its current load, which may be represented by a bandwidth allocated to one or more user equipment for wireless communication or a number of bits per second being transmitted over the air interface between the client and the user equipment. Some embodiments of the client may also predict a load in response to one or more user equipment requesting access via the client or requesting service provided by a new application. At block 510, the client attempts to detect the presence of neighboring wireless modems, e.g., by measuring signal strengths of signals transmitted by one or more neighboring wireless modems. Neighboring wireless modems may include wireless modems deployed in a neighboring home, a neighboring office building, or in an external location such as on a pole in a location near the client. The client may categorize neighboring wireless modems as candidates for aggregation if the measured signal strength exceeds a threshold signal strength.

The client may then request aggregation of a wireline backhaul interface and the candidate wireless interfaces. For example, the client can request aggregation in response to the measured (or predicted) load exceeding a load threshold that indicates that the bandwidth of the wireline backhaul interface is insufficient to support the measured load. At block 510, the client generates a request message for transmission to a server such as the policy server 240 shown in FIG. 2. Some embodiments of the request message include information identifying the client, the candidate wireless interfaces, or the channel capacities of the wireless interfaces. For example, the request message may be in the format:
REGISTER device C0:3F:D5:66:6A with:
BSSID 08:86:3B:51:98:F8, rate 300 Mbps
BSSID 08:86:3B:51:98:1A, rate 300 Mbps
BSSID 08:86:3B:D7:7E:AC, rate 65 Mbps
   The request message may therefore identify the client device and three wireless interfaces having channel capacities of 300 Mbps, 300 Mbps, and 65 Mbps, respectively. The wireless interfaces indicated in the request message may be considered candidates for aggregation with the wireline interface of the client. The client transmits the request message to the server at 515.

At block 520, the server determines the available wireline backhaul capacity (or bandwidth) at the neighboring wireless modems associated with the candidate wireless interfaces indicated in the request message. Some embodiments of the server transmit information requests to the candidate neighboring wireless modems to dynamically determine the currently available wireline backhaul capacity of the neighboring wireless modems. The candidate neighboring wireless modems may then respond with a message indicating their current availability of wireline backhaul capacity and, in some cases, a time interval during which the backhaul bandwidth is available. The server may also access information indicating availability of wireline backhaul capacity at the candidate neighboring wireless modems from a database, e.g., in the case where the actual backhaul capacity of a wireless modem is larger than the bandwidth allocated to the owner of the wireless modem by their subscription. In some embodiments, the server negotiates with the client or the neighboring wireless modem to confirm that the client is authorized to use the available wireline backhaul capacity of the neighboring wireless modem.

Once the server has selected a subset of the wireless interfaces that are to be aggregated with the client's wireline backhaul interface, the server generates (at block 530) an assignment message that includes information identifying the wireless interfaces for aggregation. For example, the assignment message may be in the format:
ASSIGNMENT
08:86:3B:51:98:F8
08:86:3B: 51:98:1A
   The assignment message may therefore identify two interfaces that may be aggregated by the client. The server transmits the assignment message to the client at 535. At block 540, the client updates the policies that are used to configure its interfaces so that the wireline backhaul interface at the client can be aggregated with the wireless interfaces indicated in the assignment message. At block 545, the client waits for any subsequent updates. Some embodiments of the client may also repeat the method 500, e.g., in response to initiation of a new flow or in response to a request from the server to update measurements of the channel conditions or perform other measurements. The method 500 may also be repeated in response to expiration of the time interval for backhaul capacity availability indicated by one or more of the neighboring wireless modems.

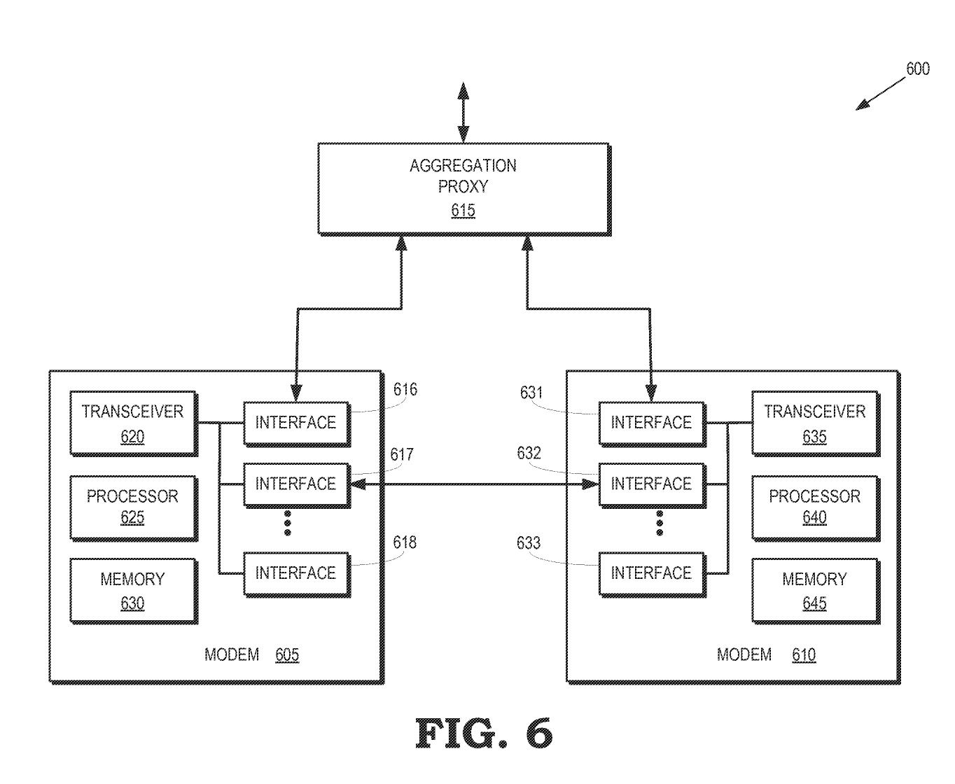

FIG. 6 is a block diagram of a wireless communication system 600 according to some embodiments. The wireless communication system 600 includes wireless modems 605, 610 and an aggregation proxy 615, which may be used to implement some embodiments of the wireless modems 105, 110 and the aggregation proxy server 160 shown in FIG. 1 or the wireless modems 221-223 and the aggregation proxy 245 shown in FIG. 2.

The wireless modem 605 includes a transceiver 620 for transmitting and receiving signals over one or more interfaces 616, 617, 618, which may referred to herein as “the interfaces 616-618.” The wireless modem 605 also includes a processor 625 and a memory 630. The processor 625 may be used to execute instructions stored in the memory 630 and to store information in the memory 630 such as the results of the executed instructions. The wireless modem 610 includes a transceiver 635 for transmitting and receiving signals over one or more interfaces 631, 632, 633, which may referred to herein as “the interfaces 631-633.” The wireless modem 610 also includes a processor 640 and a memory 645. The processor 640 may be used to execute instructions stored in the memory 645 and to store information in the memory 645 such as the results of the executed instructions. Some embodiments of the aggregation proxy 615 may also be implemented using a transceiver, a processor, and a memory, although these elements are not shown in FIG. 6 in the interest of clarity.

The interfaces 616-618 and 631-633 may be used to support wireline or wireless communication according to one or more radio access technologies and in one or more licensed or unlicensed frequency bands. For example, the interfaces 616, 631 are wireline backhaul interfaces used to establish wireline connections 650, 655 with the aggregation proxy 615. For another example, the interfaces 617, 632 are used to establish a wireless connection 660 between the wireless modems 605, 610. Additional wireless interfaces such as the interfaces 618, 633 may be used to establish wireless connectivity with one or more user equipment. Some embodiments of the wireless modems 605, 610 and the aggregation proxy 615 may therefore be configured to perform portions of the method 400 shown in FIG. 4 or the method 500 shown in FIG. 5.

Aggregating a wireline backhaul interface (such as the interface 616) with a wireless interface (such as the interface 617) increases the available capacity or bandwidth for a backhaul connection to the wireless modem 605. Some embodiments of the wireless modem 605 may use the additional backhaul capacity to support aggregation of one or more wireless interfaces to support higher bandwidth communication with one or more user equipment. For example, user equipment that accesses a flow provided by a multimedia service provider such as Netflix or Hulu through a single Wi-Fi interface may be limited to a bandwidth such as the 20 megahertz (MHz) bandwidth of a standard Wi-Fi carrier channel, or in some cases an enhanced 80 MHz or 160 MHz channel. In contrast, the bandwidth available to user equipment that accesses a flow formed of the sub-flows of several aggregated interfaces may be equal to or greater than 1000 MHz. Aggregating the sub-flows of multiple interfaces may therefore provide multi-gigabit per second wireless access capacity or user throughputs of hundreds of megabits per second. Aggregation of interfaces may include adding or removing interfaces from the subset of aggregated interfaces. Aggregation of multiple wireless interfaces at the wireless modem 605 and corresponding user equipment may be controlled using a network-side policy server and aggregation proxy combined with a policy agent and a policy-based aggregator implemented in the user equipment.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
aggregating, at a first wireless modem, a wireline backhaul interface with a wireless interface to a second wireless modem in response to receiving signaling indicating availability of wireline backhaul capacity at the second wireless modem, wherein the aggregated wireline backhaul interface and wireless interface support concurrent sub-flows of a flow.

2. The method of claim 1, further comprising:
measuring, at the first wireless modem, a strength of a signal received from the second wireless modem; and
transmitting a request to aggregate the wireline backhaul interface with the wireless interface in response to the strength exceeding a threshold signal strength.

3. The method of claim 2, further comprising:
measuring a load on the first wireless modem, and wherein transmitting the request comprises transmitting the request in response to the load exceeding a threshold load.

4. The method of claim 3, further comprising:
receiving, in response to transmitting the request, signaling instructing the first wireless modem to aggregate the wireline backhaul interface with the wireless interface.

5. The method of claim 4, wherein transmitting the request and receiving the signaling instructing the first wireless modem to aggregate the wireline backhaul interface with the wireless interface comprises transmitting the request on an uplink of a dedicated bidirectional signaling channel and receiving the signaling on a downlink of the dedicated bidirectional signaling channel.

6. The method of claim 1, further comprising:
measuring a plurality of strengths of a plurality of signals received from a plurality of wireless modems, the plurality of wireless modems including the second wireless modem;
transmitting a request to aggregate the wireline backhaul interface with a subset of a plurality of wireless interfaces to the plurality of wireless modems in response to the plurality of strengths exceeding a threshold signal strength; and
receiving, in response to transmitting the request, signaling instructing the first wireless modem to aggregate the wireline backhaul interface with the subset of the plurality of wireless interfaces.

7. The method of claim 1, further comprising:
negotiating payment for usage of the wireless interface; and
transmitting or receiving information via the wireless interface in response to negotiating the payment.

8. A method comprising:
transmitting, from a policy server, instructions to a first wireless modem to aggregate a wireline backhaul interface with a wireless interface to a second wireless modem based on availability of wireline backhaul capacity at the second wireless modem, wherein the aggregated wireline backhaul interface and wireless interface support concurrent sub-flows of a flow.

9. The method of claim 8, further comprising:
receiving a request to aggregate the wireline backhaul interface with the wireless interface in response to a strength of a signal received at the first wireless modem from the second wireless modem exceeding a threshold signal strength.

10. The method of claim 9, wherein receiving the request comprises receiving the request in response to a load on the first wireless modem exceeding a threshold load.

11. The method of claim 9, wherein transmitting the instructions and receiving the request comprises transmitting the instructions on a downlink of a dedicated bidirectional signaling channel and receiving the request on an uplink of the dedicated bidirectional signaling channel.

12. The method of claim 8, further comprising:
detecting the availability of wireline backhaul capacity by transmitting a request to the second wireless modem for information indicating unallocated wireline backhaul capacity at the second wireless modem and receiving the information indicating the unallocated wireline backhaul capacity response to transmitting the request.

13. The method of claim 8, further comprising:
transmitting a request to aggregate the wireline backhaul interface with at least one of a plurality of wireless interfaces to a plurality of wireless modems in response to a plurality of strengths of a plurality of signals received from the plurality of second wireless modems exceeding a threshold signal strength, the plurality of wireless modems comprising the second wireless modem;
selecting a subset of the plurality of wireless interfaces; and
transmitting instructions to the first wireless modem to aggregate the wireline backhaul interface with the subset of the plurality of wireless interfaces.

14. The method of claim 8, further comprising:
negotiating payment for usage of the wireless interface; and
transmitting or receiving information via the wireless interface in response to negotiating the payment.

15. A wireless modem, comprising:
a wireline backhaul interface and a wireless interface; and
a processor to aggregate the wireline backhaul interface the wireless interface in response to receiving signaling indicating availability of wireline backhaul capacity at another wireless modem, wherein the aggregated wireline backhaul interface and wireless interface support concurrent sub-flows of a flow.

16. The wireless modem of claim 15, further comprising:
a transceiver to measure a strength of a signal received from the other wireless modem and transmit a request to aggregate the wireline backhaul interface with the wireless interface in response to the strength exceeding a threshold signal strength.

17. The wireless modem of claim 16, wherein the transceiver is to measure a load on the wireless modem and transmit the request in response to the load exceeding a threshold load.

18. The wireless modem of claim 17, wherein the transceiver is to receive, in response to transmitting the request, signaling instructing the wireless modem to aggregate the wireline backhaul interface with the wireless interface.

19. The wireless modem of claim 18, wherein the transceiver is to transmit the request on an uplink of a dedicated bidirectional signaling channel and receive the signaling on a downlink of the dedicated bidirectional signaling channel.

20. The wireless modem of claim 16, wherein the transceiver is to measure a plurality of strengths of a plurality of signals received from a plurality of other wireless modems, transmit a request to aggregate the wireline backhaul interface with a subset of a plurality of wireless interfaces to the plurality of other wireless modems in response to the plurality of strengths exceeding a threshold signal strength, and receive, in response to transmitting the request, signaling instructing the wireless modem to aggregate the wireline backhaul interface with the subset of the plurality of wireless interfaces.

21. The wireless modem of claim 15, wherein the processor is to negotiate payment for usage of the wireless interface, and wherein the transmitter is to transmit or receive information via the wireless interface in response to negotiating the payment.

22. An apparatus comprising:
a transceiver to transmit instructions to aggregate a wireline backhaul interface in a first wireless modem with a wireless interface to a second wireless modem based on availability of wireline backhaul capacity at the second wireless modem, wherein the aggregated wireline backhaul interface and wireless interface support concurrent sub-flows of a flow.

23. The apparatus of claim 22, wherein the transceiver is to receive a request to aggregate the wireline backhaul interface with the wireless interface in response to a strength of a signal received at the first wireless modem from the second wireless modem exceeding a threshold signal strength.

24. The apparatus of claim 23, wherein the transceiver is to receive the request in response to a load on the first wireless modem exceeding a threshold load.

25. The apparatus of claim 23, wherein the transceiver is to transmit the instructions on a downlink of a dedicated bidirectional signaling channel and receive the request on an uplink of the dedicated bidirectional signaling channel.

26. The apparatus of claim 22, further comprising:
a processor to detect the availability of wireline backhaul capacity in response to the transceiver transmitting a request to the second wireless modem for information indicating unallocated wireline backhaul capacity at the second wireless modem and receiving the information indicating the unallocated wireline backhaul capacity response to transmitting the request.

27. The apparatus of claim 26, wherein the transceiver is to transmit a request to aggregate the wireline backhaul interface with at least one of a plurality of wireless interfaces to a plurality of second wireless modems in response to a plurality of strengths of a plurality of signals received from the plurality of second wireless modems exceeding a threshold signal strength, and wherein the processor is to select a subset of the plurality of wireless interfaces, and wherein the transceiver is to transmit signaling instructing the first wireless modem to aggregate the wireline backhaul interface with the subset of the plurality of wireless interfaces.

28. The apparatus of claim 22, wherein the processor is to negotiate payment for usage of the wireless interface, and wherein the transceiver is to transmit or receive information via the wireless interface in response to negotiating the payment.
